(19) United States
(12) Patent Application Publication
(10) Pub. No.: US 2002/0062185 A1
(43) Pub. Date: May 23, 2002

(54) USER-SPECIFIC VEHICLE

(76) Inventors: WOLFGANG RUNGE, RAVENSBURG (DE); JOSEF SCHWARZ, FRIEDRICHSHAFEN (DE)

Correspondence Address: DAVIS & BUJOLD, 500 NORTH COMMERCIAL STREET, FOURTH FLOOR, MANCHESTER, NH, 03101, US

(21) Appl. No.: 09/462,007

(22) PCT Filed: Jun. 27, 1998
(86) PCT No.: PCT/EP98/03939

(30) Foreign Application Priority Data
Jul. 2, 1997 (DE) 197 28 226.1

(51) Int. Cl. G06F 7/00

(52) U.S. Cl. 701/49; 701/1

(57) ABSTRACT

The invention relates to a user-specific vehicle with adjustable and settable components such as an engine, transmission, running, gear, seats, anti-theft device, air conditioning, etc. The identity of the driver is determined for user-specific configuration of a component. The user-specific characteristics are recalled or set. Then follows a user-specific setting of the component. Said setting can be conducted by the manufacturer at the end of the production line at customer's request or individually when the driver operates the vehicle.

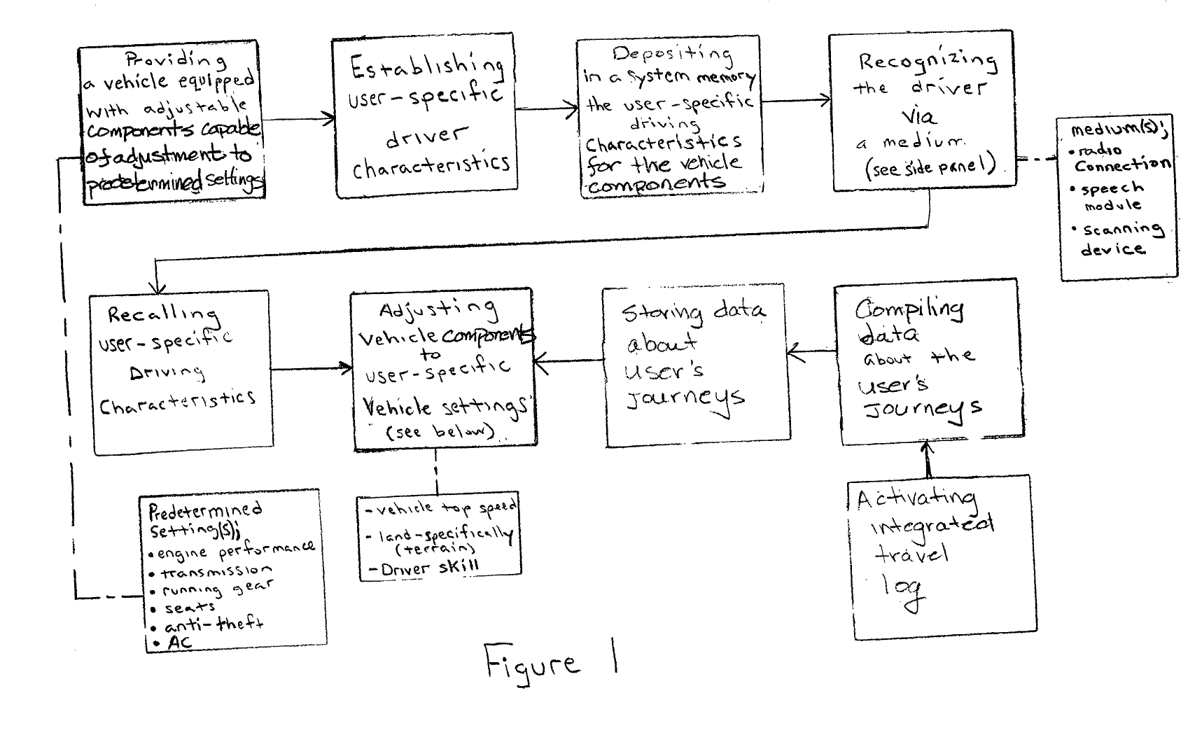

The invention relates to a vehicle and in particular concerns the user-specific configuration of components.

From the prior art are to be regarded as known already a series of proposals intended to adapt individual components of the vehicle to the individual requirements of the occupant of the vehicle. For example, known are so-called intelligent shift programs, which can recognize the driver, and, according to his driving mode, activate a certain shift program.

Also known are devices which serve to find again a seat position that was once pre-selected. In the case of the seat according to DE-C2 40 22 433, a device is provided to prevent the driver's fatigue. Other proposals concern the detection of stress situations produced by sudden dangerous situations. In such situations the malfunctioning of a component can be counteracted.

Sets of accessories (kits) in order subsequently to change the characteristics of components can be commercially found. For example, to these belong software kits with which can be changed, e.g. the running characteristic of an engine.

The problem on which this invention is based is to make available possibilities for the user-specific configuration of a vehicle.

In a vehicle with adjustable and settable components such as engine, transmission, running gear, seats, anti-theft device, air conditioning, etc., this problem is solved by the added features that for the user-specific configuration of at least one component, the identity of the driver is established, the user-specific characteristics are recalled and/or set with the aid of the identity and of the user-specific characteristics, a user-specific setting of the components can be effected.

Advantageous developments are to be understood from claims 2 to 16.

From the explanation that follows are to be understood different solutions and the advantages associated therewith for user-specific configuration of a vehicle:

The solutions proposed depart from the knowledge that conducive to user-specific configuration of a vehicle are considerations like:

for whom are individual settings conducted?

(recognition of a specific user);

what is affected:

(user-specific characteristic):

which settings are effected?

(user-specific setting) and

when does the setting occur and in addition with what medium is the setting effected?

Recognition of specific user:

The identity of a certain person such as the driver or co-drivers can be conducted with the aid of data which the driver communicates to the system. Adequate parameters can be transmitted by a sender (transponder). The sender, e.g. can be lodged in the finger ring or in the wrist watch. The data can also be deposited in the system memory and activated by a suitable medium such as speech, chip card, the input of a personal identification number or the like. In this connection the activation of the anti-theft device is possible by: detection of the finger print on the shift lever. The deactivation of the anti-theft device can be combined with other variables such as an alcohol test or the like.

User-specific characteristics:

The personal requirement profile of a driver on the component of a vehicle can be chosen by the driver himself, e.g. when purchasing a new car. User-specific characteristics can then be set by the manufacturer, e.g. at the end of the production line. Land-specific requirements can also be taken into account here. In certain user-specific characteristics such as driving mode, it is convenient to dial up said characteristics at the start of the travel. To these can belong the selection of the seat position, the choice of a certain shifting strategy, etc. In this case the user himself determines the user-specific characteristics.

User-specific setting:

These settings can be implemented by training operations. Together with the driver recognition the distance covered can be learned (distance leaning function). A shifting program can be dialed up which also informs the driver about the consequences associated therewith. Upon recognition of a specific user, an integrated travel log can be activated and indications about the covered distance can be understood and stored. A program for maintaining certain top speeds—also depending on the learned covered distance—can also be activated. When the result of an inquiry of the user-specific characteristic makes it possible to detect that the driver is under stress load, assistance functions can be called up. Among these are a kilometer-dependent alarm function, the programming of the top speed, the selection of the braking function, etc.

To the components primarily considered for user-specific settings belong the engine, the transmission, the running gear, the air conditioning.

For user-specific setting at the end of the production line are adequate in the first place pre-programmed memory modules to recognize the specific user, his specific characteristics and the standard or means to train certain operations.

When the user himself undertakes said setting, this requires adequate information possibilities in the vehicle proper. For profile setting a terminal is adequate in which - similarly to an equalizer - a certain shifting strategy, e.g. can be pre-selected via displaceable or rotatable setting elements.

A defined functionality can be set by such terminals. This means that dialing or switching off certain modules is manually possible. For this purpose are used primarily: disconnecting of the ABS function, connecting or disconnecting of the tempomat function, of anti-slip regulation. In the braking process an upshift can be prevented.

The top speed can be pre-selected land-specifically or depending on the driving ability of the driver. Here can be differentiated, e.g. between a beginner and an advanced driver. As medium for the user-specific configuration are considered: a radio connection which has great advantages with regard to freedom of arrangement, a speech module both for identification of the driver and also from the input of user settings. A scanning device can be used for personal recognition.

Similarly as is familiar to the PC user in the formation of his desk-top surface, the indicator symbols can be programmed. Switching and indicator symbols can be added or switched off. The size of the symbols or indicator instruments, the same as the optical appearance thereof, can be freely selected. For input of the person recognition of the user-specific characteristics for user-specific setting, a chip card can be used. Adequate information can be deposited in a memory module within the code which in addition, when the code is used as transponder, can be communicated to the vehicle system—as a rule when the vehicle door is open.

1. The vehicle with adjustable and settable components such as engine, transmission, running gear, anti-theft device, air conditioning, etc., characterized in that for user-specific configuration of at least one component, the identity of the driver is established, the user-specific characteristics are recalled and/or adjusted and with the aid of the identity and of the user-specific characteristics, the component is user-specific set.

2. The vehicle according to claim 1, characterized in that the user-specific characteristics are set by the manufacturer, for ex., at the end of the production line.

3. The vehicle according to claim 1, characterized in that the user-specific characteristics are determined by the driver.

4. The vehicle according to claim 1, characterized in that the identity of the driver is determined with the aid of data which the driver communicates to the system.

5. The vehicle according to claim 4, characterized in that the user-specific data are deposited in a system memory and are activated by an adequate medium such as speech, a chip card, the input of a personal identification number, or the like.

6. The vehicle according to claim 5, characterized in that an anti-theft device is activated by the recognition of a finger print of the driver on the switch lever while the deactivation is combined with other variables such as an alcohol test.

7. The vehicle according to claim 1, characterized in that the user-specific setting takes effect by training operations.

8. The vehicle according to claim 7, characterized in that the covered distance is learned.

9. The vehicle according to claim 4, characterized in that when a specific user is recognized, an integrated travel log is activated and indications about the distance covered left behind are detected and stored.

10. The vehicle according to claim 2, characterized in that for the user-specific setting at the end of the production line, pre-programmed memory modules for recognition of the specific user, of his specific characteristics and the standard or means for training certain operations are used.

11. The vehicle according to claim 3, characterized in that the user undertakes himself the user-specific setting and that for this purpose a terminal is provided which has available displaceable and rotational adjustment elements with which, for ex., a certain shift strategy can be pre-selected.

12. The vehicle according to claim 3, characterized in that a defined functionality is set.

13. The vehicle according to claim 1, characterized in that operating parameters such as the top speed of the vehicle, land-specifically or depending on the driving ability of the driver, can be pre-selected.

14. The vehicle according to claim 5, characterized in that as medium for the user-specific configuration, a radio connection , a speech module or a scanning device is used.

15. The vehicle according to claim 3, characterized in that indicator symbols can be programmed in the manner of a desk-top surface.

16. The vehicle according to claim 5, characterized in that for the input of the person recognition and the user-specific characteristics for user-specific setting of a component, a memory module is used and the information deposited is communicated to the vehicle system, for ex., by opening the vehicle door.
